(19) United States
(12) Patent Application Publication
(10) Pub. No.: US 2004/0074358 A1
(43) Pub. Date: Apr. 22, 2004

(54) Apparatus for processing binding film for manufacturing copper clad laminate board and circuit board

(75) Inventor: Chiu-Fong Huang, Panchiao City (TW)

Correspondence Address: BACON & THOMAS, PLLC, 625 SLATERS LANE, FOURTH FLOOR, ALEXANDRIA, VA, 22314

(73) Assignee: USUN TECHNOLOGY CO., LTD., Taoyuan Hsien (TW)

(21) Appl. No.: 10/274,139

(22) Filed: Oct. 21, 2002

(51) Int. Cl. B26D 1/56; B23D 25/02

(52) U.S. Cl. 83/171; 271/8.1; 83/16

(57) ABSTRACT

An apparatus for processing binding film is provided. The apparatus comprises a workstation board and a feeder for supplying the binding film, wherein the feeder is disposed at a front-end side of the workstation board. A separating set comprising a metering roller and a plurality of knifes, a slot-flush set comprising a plurality of flushing heads, and a knife set, are disposed at predetermined positions over the workstation board. The slot flushing, separation and cutting process steps are executed in a single step. A receiving section is disposed at a distal end side of the workstation board and behind the knife set. The processed binding film sheets are automatically received and stacked.

### BACKGROUND OF THE INVENTION

1. Field of the Invention

The present invention relates to an apparatus for processing a binding film, and more particularly, the present invention relates to an apparatus for processing the binding film, comprising a feeder for feeding the binding film capable of flushing, separating and cutting the binding film in one step on a workstation, thereby substantially reducing the processing time, simplifying the process, reducing the capital investment on the machine cost, and at the same time eliminating or substantially reducing the generation of powder during separation and/or cutting process.

2. Description of the Related Art

Due to the rapid advancement in computer and information technologies, a greater need for an improved and good quality circuit board is created. The circuit board can be classified as hard board and soft board according to the softness, single face, double face or multi-face according to the shape, or paper-based copper clad laminate, complex laminate, glass fabric sheet copper clad, hard or soft copper clad laminate, porcelain laminate, metal laminate, thermoplastic laminate and others according to the material. When using a soft circuit board, the copper clad laminate (CCL) is an essential and a crucial basic component for producing printing circuit board. The insulation paper, fiberglass sheet or other fibrous material are blended into a resin to produce a binding film, for example, prepegs, is used for forming the inter-adhesive layer. A copper foil is then adhered on one of the surfaces or both the surfaces of the binding film. Next, resulting structure is subjected to a high temperature and pressure. The copper foil surface is etched to form a conductive circuit, through-holes are formed as extended from the resin surface opposite to the copper foil to the conductive circuit by laser irradiation, and further a conductive substance is filled in each through-hole to form a via hole for connecting with the circuit. A plurality of such circuit boards is stacked one on the other with an adhesive layer being laid between them, and they are hot—pressed together as described above to produce a multi-layer printed wiring board according to the design requirement. The binding film is for insulating and supporting the electric components. However, since the binding film is usually rolled up onto a roller as a raw material, and therefore during the processing of the slots need to be flushed, then the binding film needs to be separated and cut into a binding film of suitable size, and manually stacked. Then the binding film is covered by the pins and arrayed in the end process. Finally, the resulting structure is subjected to a high temperature and pressure for producing the multi-layer printing circuit board. The valuable machine for treating the binding film is capable of only processing the steps of cutting, separation and receiving material manually, with one step at a time, and therefore requires an additional apparatus for processing slot-flush of the binding film. This would increase the labor cost as well as the capital investment cost on machine, thus increasing the overall manufacturing.

A mass of powder will be generated while processing separation and cutting of the binding film. The generated powder will easily adhere to the surface of the binding film due to the static current and therefore causing contamination and damage to the circuit when the contaminated binding film is used for making the printed circuit board. Further, this would also cause inconsistency in the quality of the printed circuit boards. Besides, the powder generated during the process can seriously jeopardize operators' health.

Accordingly, prevention of powder generation during the process is highly desirable for good manufacturing practice (GMP) eliminate or substantially reduce health hazard as well as effectively improve the circuit board quality.

### SUMMARY OF THE INVENTION

Accordingly, in the view of the foregoing, the present inventor makes a detailed study of related art to evaluate and consider, and uses years of accumulated experience in this field, and through several experiments, to create an apparatus for processing binding film of the present invention. The present invention provides an innovated cost effective apparatus for processing binding film for manufacturing a copper clad laminate and circuit board for printed wiring board.

Accordingly, it is an object of the present invention to provide apparatus for processing a binding film, which is capable of eliminating, or substantially reducing the generation of powder during the processing of the binding film, thus the adverse health effect can be effective eliminated or substantially reduced. At the same time the quality of the processed binding film is promoted.

It is another object of the present invention to provide a scheme for substantially reducing the overall cost of the processing of the binding film.

It is another object of the present invention to provide a scheme wherein the slot flushing, the separation and the cutting step can be executed by a single step. Thus the processing time can be substantially reduced and therefore the production throughput can be substantially promoted. This would further simplify the processing steps.

It is another object of the present invention to provide a scheme wherein the processed binding film sheets can be automatically collected and stacked. Thus the manual operation of receiving and stacking of the processed binding film sheets can be effectively eliminated. Thus, processing time can be substantially reduced and therefore the production throughput can be substantially promoted. This would further simplify the processing steps.

In order achieve the above objects and other objects of the present invention, an apparatus for processing binding film is provided. The apparatus comprises a workstation board and a feeder for supplying the binding film, is disposed at a front-end side of the workstation board. The feeder is supported on a base. A separating set comprising a metering roller and a plurality of knifes is disposed at predetermined positions over the workstation board. A slot-flush set is disposed at a predetermined position at an upstream side of the separating set over the workstation board. The slot-flush set comprises a plurality of flushing heads. A knife set is disposed at a predetermined position at the downstream side of the separating set over the workstation board. A receiving section is disposed at a distal end side of the workstation board and behind the knife set. A plurality of heating devices is disposed at a predetermined positions over the workstation board, for example, in between the slot-flush set and the knifes, in between the knifes and the metering roller, and in between the metering roller and the knife set. The heating devices are for heating the binding film to soften the binding film to certain softness in order to enable the binding film to easily separate and extend during separation step and for effectively reducing generation of powder during the cutting step during the processing of the binding film. Thus, adverse health effects to the operators can be effective eliminated or substantially reduced. Further, the contamination of the binding film with the generated powder during the processing of the binding film can also be effectively eliminated or substantially reduced. Thus the quality of the binding film can be effectively promoted.

According to an aspect of the present invention, the binding film is rolled up on the feeder that is positioned on the base on a front-end side of the workstation board. The binding film is pulled and extended over the workstation board and positioned below the separating set until the binding film to reaches a rear side of the metering roller of the separating on the workstation board. The metering roller is for measuring and controlling the cutting length of the binding film by determining the number and extent of rotation of the metering roller so that a desired length for each binding film sheet cut can be effectively achieved.

According to another aspect of the present invention, when the metering roller rotates, the binding film is pulled to a preset length by the metering roller, the separation step can be executed by using one or more of knifes of the separating set to separate the binding film which stretched over several sections directly and continuously.

According to another aspect of the present invention, slot-flushing, separation and cutting process steps on the binding film are executed simultaneously in a single step.

According to another aspect of the present invention, a receiving section is disposed at a downstream side of the knife set. The receiving section comprises a plurality of rollers, an adjustable roller, and a block plate disposed at a distal end of the receiving section. The rollers drive the adjustable roller along with a transport belt. The position of the adjusting roller can be adjusted for adjusting the transport distance between the rollers and the adjustable roller, and thereby a width of a gap between the adjustable roller and block plate can be adjusted so that the processed binding film can pass through the gap and get collected in a receiving chamber which placed below.

According to another aspect of the present invention, apparatus for processing binding film comprises only few processing elements disposed over its surface and also since the slot-flushing, the separation and the cutting process steps in a single step, thus the capital investment on the machine and the processing time are all substantially reduced. Thus, the overall manufacturing cost can be substantially reduced.

According to another aspect of the present invention, because the infrared ray tube is used in the heating device of the present invention for heating the binding film in order to soften the binding film to certain softness, therefore, generation of harmful powder during the processing of the binding film can be effectively eliminated or substantially reduced. Thus adverse health effects to the operators can be eliminated or substantially reduced. Further, since the contamination of the processed binding film can be eliminated or substantially reduced due to elimination or substantial reduction of generation of contaminating powder during the processing of the binding film. Thus the quality of the processed binding film can be effectively promoted.

### BRIEF DESCRIPTION OF THE DRAWINGS

FIG. 1 is a side view of an apparatus for processing binding film showing before slot-flushing and cutting process steps on a binding film according to the present invention;

FIG. 2 is a side view of the apparatus for processing binding film showing while processing the slot-flushing and cutting process steps on the binding film according to the present invention;

FIG. 3 is a side view of the embodiment showing the receiving section apparatus for processing binding film of the present invention; and

FIG. 4 is a side view of the embodiment showing while receiving the processed binding film sheet according to the present invention.

### DESCRIPTION OF THE PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

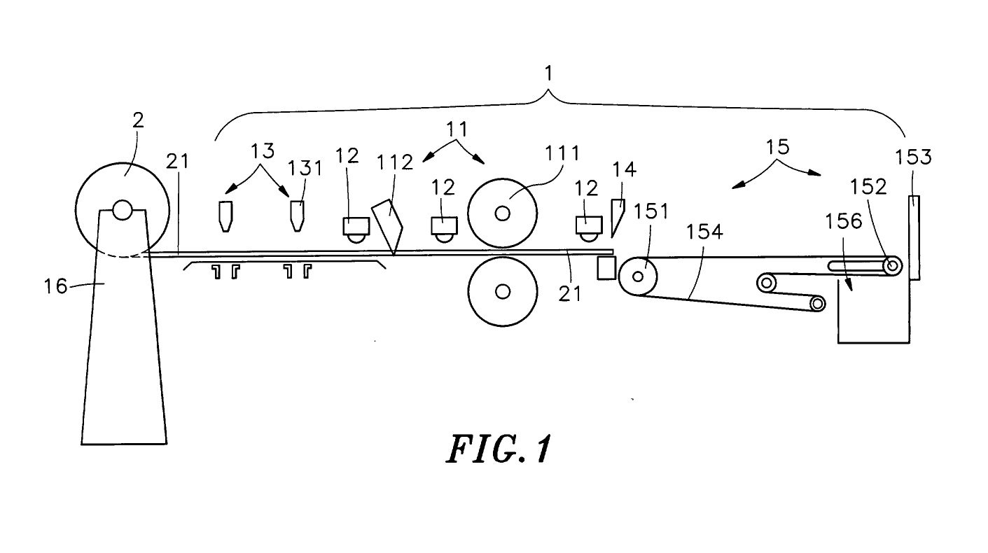

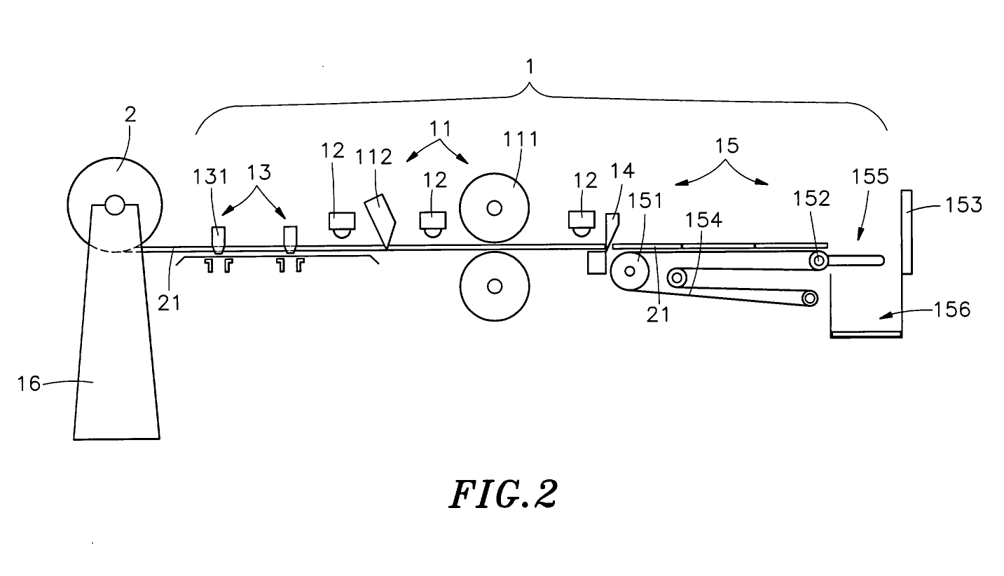

Referring to FIGS. 1 and 2, show various embodiments of the apparatus for processing binding film of the present invention. The apparatus comprises a workstation board 1 and a feeder 2 for supplying the binding film 21, is disposed at a front-end side of the workstation board 1. The feeder 2 is supported on a base 16. A separating set 11 comprising a metering roller 111 and a plurality of knifes 112 is disposed at predetermined positions over the workstation board 1. A slot-flush set 13 is disposed at a predetermined position at an upstream side of the separating set 11 over the workstation board 1. The slot-flush set 13 comprises a plurality of flushing heads 131. A knife set 14 is disposed at a predetermined position at the downstream side of the separating set 11 over the workstation board 1. A receiving section 15 is disposed at a distal end side of the workstation board 1 and behind the knife set 14. A plurality of beating devices 12 is disposed at a predetermined positions over the workstation board 1, for example, in between the slot-flush set 13 and the knifes 112, in between the knifes 112 and the metering roller 111, and in between the metering roller 111 and the knife set 14. The heating devices 12 are for heating the binding film 21 to render the binding film 21 to certain softness in order to enable the binding film 21 to easily separate and extend during separation step and for effectively reducing generation of powder during the cutting step during the processing of the binding film 21. Thus, adverse health effects to the operators can be effective eliminated or substantially reduced. Further, the contamination of the binding film 21 with the generated powder during the processing of the binding film 21 can also be effectively eliminated or substantially reduced. Thus the quality of the binding film 21 can be effectively promoted.

Further, the above-mentioned heating devices 12 for example, comprise infrared ray tubes and the like for generating heat.

The operation of the apparatus for processing binding film of the present invention is described as follows. The binding film 21 is rolled up on the feeder 2 that is positioned on the base 16 on a front-end side of the workstation board 1. The binding film 21 is pulled and extended over the workstation board 1 and positioned below the separating set 11 until the binding film 21 to reaches a rear side of the metering roller 111 of the separating 11 on the workstation board 1. The metering roller 111 is for measuring and controlling the cutting length of the binding film 21 by determining the number and extent of rotation of the metering roller 111 so that a desired length for each binding film 21 sheet cut can be effectively achieved. While the metering roller 111 rotates, the binding film 21 is pulled to a preset length by the metering roller 111, the separation step can be executed by using one or more of knifes 112 of the separating set 11 to separate the binding film 21 which stretched over several sections directly and continuously. When the metering roller 111 stops, the plurality of flushing heads 131 and the knife set 14 execute the slot-flushing and cutting process steps simultaneously on the binding film 21. Knifes 112 cut the binding film 21 in a horizontal direction with respect to the binding film 21 feeding direction. As a result, a plurality of apertures are formed on the un-separated binding film 21, and meanwhile the knife set 14 cuts a portion of the separated binding film 21 at a predetermined position directly, wherein the knife set 14 cuts in a perpendicular direction with respect to the binding film 21 feeding direction. Thus slot flushing, separation and cutting process steps on the binding film 21 are executed simultaneously in a single step.

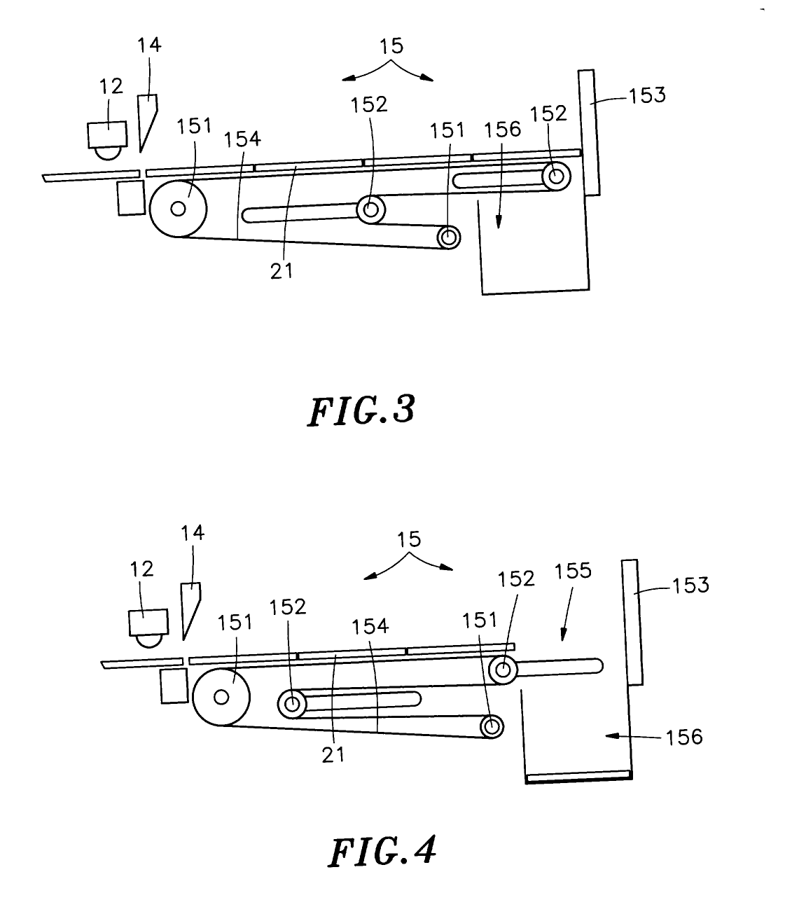

Referring to FIGS. 3 and 4, show the various embodiments of the receiving section 15 of the present invention. The receiving section 15 is disposed at a downstream side of the knife set 14. The receiving section 15 comprises a plurality of rollers 151, an adjustable roller 152, and a block plate 153 disposed at a distal end of the receiving section 15. The rollers 151 drive the adjustable roller 152 along with a transport belt 154. The position of the adjusting roller 152 can be adjusted for adjusting the transport distance between the rollers 151 and the adjustable roller 152, and thereby a width of a gap 155 between the adjustable roller 152 and block plate 153 can be adjusted so that the processed binding film 21 can pass through the gap 155 and get collected in a receiving chamber 156 which placed below. A lower end of the block plate 153 is supported by the receiving chamber 156. The above-mentioned receiving section 15 is only described as an example and therefore this is intended not to limit the scope of the present invention.

Thus, the apparatus for processing binding film of the present invention is provided to resolve the aforementioned drawbacks of the conventional art and to substantially simplify the processing of the binding film, and reduce the overall manufacturing cost. The advantages of the apparatus for processing binding film of the present invention are:

1) The workstation board 1 comprises only few processing elements disposed over its surface such as the slot-flush set 13, the separating set 11 and the knife set 14 for processing the slot-flushing, the separation and the cutting process steps in a single step. Thus the capital investment on the machine and the processing time are all substantially reduced. Thus, the overall manufacturing cost can be substantially reduced.

2) Since the infrared ray tube is used in the heating device 12 of the present invention for heating the binding film 21 in order to soften the binding film 21 to certain softness, therefore, generation of harmful powder during the processing of the binding film 21 can be effectively eliminated or substantially reduced. Thus adverse health effects to the operators can be eliminated or substantially reduced. Further, since the contamination of the processed binding film 21 can be eliminated or substantially reduced due to elimination or substantial reduction of generation of contaminating powder during the processing of the binding film 21. Thus the quality of the processed binding film 21 can be effectively promoted.

3) In addition the present invention not only teaches the scheme of executing slot-flushing, separation and the cutting process steps in a single step, but also teaches the use of the receiving section 15 for automatically receiving the and stacking the processed binding film 21. Thus the manual receiving and stacking operations can be effectively eliminated. Therefore the labor cost can be reduced and thus the manufacturing cost can be further reduced.

While the invention has been described in conjunction with a specific best mode, it is to be understood that many alternatives, modifications, and variations will be apparent to those skilled in the art in light of the a foregoing description. Accordingly, it is intended to embrace all such alternatives, modifications, and variations, which fall within the spirit and scope of the included claims. All matters set forth herein or shown in the accompanying drawings are to be interpreted in an illustrative and non-limiting sense.

What the invention claimed is:

1. An apparatus for processing binding film, comprising:
a workstation board supported by a base wherein a front side of the workstation board is supported by the base;
a feeder disposed on the base for supplying a binding film and positioning the binding film onto the workstation board;
a slot-flush set disposed at a downstream side of the base over a surface of the workstation board, wherein the slot-flush set comprises a plurality of flushing heads;
a separating set disposed at a downstream side of the slot-flush set over a surface of the work station board, wherein the separating set comprises at least one knife and a metering roller, and wherein the metering roller is for pulling the binding film to a preset length and said knife is for cutting the binding film in a horizontal direction with respect to a binding film feeding direction; and
a knife set is disposed at a downstream side of the separating set over a surface of the workstation board, for cutting the binding film in a perpendicular direction with respect to the binding film feeding direction.

2. The apparatus of claim 1, wherein an infrared ray heating device is disposed at a frontal side of the separating set.

3. The apparatus of claim 1, wherein an infrared ray heating device is disposed at a frontal side of the knife set.

4. The apparatus of claim 1, wherein the receiving section is positioned at a distal end of the workstation board and behind the knife set.

5. The apparatus machine of claim 1, wherein the receiving section comprises a plurality of rollers, an adjustable roller, and a block plate, wherein the rollers drive a transport belt and the adjustable roller.
